(19) United States
(12) Patent Application Publication
(10) Pub. No.: US 2019/0180207 A1
(43) Pub. Date: Jun. 13, 2019

(54) SYSTEM AND METHOD FOR MANAGING RISK FACTORS IN AEO (AUTHORIZED ECONOMIC OPERATOR) CERTIFICATE PROCESS

(71) Applicant: ELECTRONICS AND TELECOMMUNICATIONS RESEARCH INSTITUTE, Daejeon (KR)

(72) Inventors: Je Youn DONG, Daegu (KR); Ki Young MOON, Sejong-si (KR); Ki Duck KIM, Daegu (KR); Soo In LEE, Daegu (KR)

(21) Appl. No.: 15/990,038

(22) Filed: May 25, 2018

(30) Foreign Application Priority Data
Dec. 12, 2017 (KR) 10-2017-0170353

(51) Int. Cl. G06Q 10/06; G06Q 30/00

(52) U.S. Cl. CPC G06Q 10/0635; G06Q 30/018

(57) ABSTRACT

A risk management system according to present invention includes a central management server including at least one processor. The processor creates a risk level assessment table based on set likelihood evaluation criteria scores and set consequence evaluation criteria scores, creates a risk factor check list based on information regarding risks and risk factors input by a user, the risks and the risk factors being provided according to tasks, creates an error log based on externally-provided raw data and first user input information, creates a discrepancy log based on externally-provided abnormal event information and second user input information, and creates a risk factor identification and evaluation table based on the risk factor check list, the error log, and the discrepancy log.

### CROSS REFERENCE TO RELATED APPLICATION

The present application claims priority from Korean Patent Application Number 10-2017-0170353, filed on Dec. 12, 2017, the entire contents of which are incorporated herein for all purposes by this reference.

### BACKGROUND

### Field

The present disclosure relates, in general, to risk factor management technology in an authorized economic operator (AEO) certificate process, and more particularly, to a system and method for managing risk factors to improve a score with regard to law compliance, as key references, in AEO certificate.

### Description

The authorized economic operator (AEO) is a policy by which national customs administrations approve companies strictly complying with laws as being highly reliable. Such reliable companies are granted benefits in customs procedures, such as quick clearance or omission of inspection, not only by domestic customs administrations but also by foreign customs administrations.

For AEO certificate, four main certificate standards must be satisfied. That is, an AEO certificate cannot be acquired unless all of certificate standards belonging to four categories, namely, law compliance, internal control system, financial soundness, and security management, are satisfied.

To improve scores with regard to law compliance, conception as to and execution of risk management for reducing error scores, e.g. by correction and withdrawal of export and import declarations, are essential requirements.

In addition, since the infringement of laws and regulations regarding national clearance, such as customs laws, is also an important factor with regard to law compliance, the infringement of laws and regulations must also be managed.

It is therefore necessary to inspect and improve processes based on risk assessment techniques in an internal control system, i.e. one of the AEO certificate standards.

In general, it is possible to manage errors in import and export declarations by devising improvement measures, such as by categorizing errors in import and export declarations and analyzing the reasons for main errors.

However, for error management, paperwork including a significant amount of documents, such as documents related to errors, countermeasures, and assessment sheets, must be performed. When such paperwork is manually performed, a large amount of time, costs (e.g. consulting costs), and labor costs (e.g. personnel preparing for certificate) are required, which is problematic.

In addition, after certificate, a large amount of time, costs, and labor costs may also be required for post management (e.g. assessment and management of improvement measures).

### BRIEF SUMMARY

Various aspects of the present disclosure provide a system and method for managing risk factors to improve scores with regard to law compliance, as key references, in authorized economic operator (AEO) certificate.

According to an aspect, provided is a system for managing risk factors in an AEO certificate process. The system may include a central management server including at least one processor. The processor may create a risk level assessment table based on set likelihood evaluation criteria scores and set consequence evaluation criteria scores; create a risk factor check list based on information regarding risks and risk factors input by a user, the risks and the risk factors being provided according to tasks; create an error log based on externally-provided raw data and first user input information; create a discrepancy log based on externally-provided abnormal event information and second user input information; and create a risk factor identification and evaluation table based on the risk factor check list, the error log, and the discrepancy log.

The likelihood evaluation criteria scores may be category-specific likelihood evaluation criteria scores set to be within a plurality of categories classified according to likelihood evaluation criteria assessment standards, while the consequence evaluation criteria scores may be category-specific consequence evaluation criteria scores set to be within a plurality categories classified according to consequence evaluation criteria assessment standards. The processor may create the risk level assessment table comprised of scores obtained by multiplying the category-specific likelihood evaluation criteria scores and the category-specific consequence evaluation criteria scores.

The tasks may be classified by categories, subcategories, and sub-subcategories. The processor may match codes to the tasks classified by the sub-subcategories, which are lowest categories.

The processor may extract information, including liable person code, declaration number, block number, correction date and time, repair category, correction category, item code, error score, error score after change, details before correction, and details after correction, from the raw data, and input the extracted information to the error log.

When the information extracted from the raw data is input to the error log, the processor may input the extracted information to the error log to be arranged based on the declaration number information.

The processor may receive information regarding reasons for liability, information regarding analysis of causes of errors, task classification information, risk factor information, and consequence evaluation criteria information, as the first user input information; and code and manage error details in the error log, based on the task classification information and the risk factor information, the error details in the error log being managed by being matched to codes used in management of the risk factor check list.

The processor may receive task classification information, risk factor information, and consequence evaluation criteria information, according to the abnormal event information, as the second user input information; and code and manage details of abnormal events in the discrepancy log, based on the task classification information and the risk factor information, the details of abnormal events in the discrepancy log being managed by being matched to codes used in the management of the risk factor check list.

The processor may input information read from the risk factor check list to the risk factor identification and evaluation table; input likelihood evaluation criteria scores determined by comparing numbers of code-specific errors, among errors in the error log, with law compliance standards of likelihood evaluation criteria assessment standards used for setting likelihood evaluation criteria scores, as likelihood evaluation criteria information, to the risk factor identification and evaluation table; input likelihood evaluation criteria scores determined by comparing numbers of code-specific abnormal events, among abnormal events in the discrepancy log, with security management standards of likelihood evaluation criteria assessment standards, as likelihood evaluation criteria information, to the risk factor identification and evaluation table; and inspect event-specific consequence evaluation criteria information while counting the errors in the error log and the abnormal events in the discrepancy log, and inputs the event-specific consequence evaluation criteria information to the risk factor identification and evaluation table.

The processor may calculate degrees of risk based on the likelihood evaluation criteria information and the consequence evaluation criteria information, determine levels of risk by comparing the calculated degrees of risk with the risk level assessment table, and input the degrees of risk and the levels of risk to the risk factor identification and evaluation table.

When a level of risk is high, the processor may create and input a management number to the risk factor identification and evaluation table, and after having created the management number, creates a report of risk security measures and a report of evaluation of corrective action plan, in connection with the management number.

According to an aspect, provided is a method of managing risk factors in an AEO certificate process. The method may include: creating a risk level assessment table based on set likelihood evaluation criteria scores and set consequence evaluation criteria scores; creating a risk factor check list based on information regarding risks and risk factors input by a user, the risks and the risk factors being provided according to tasks; creating an error log based on externally-provided raw data and first user input information; creating a discrepancy log based on externally-provided abnormal event information and second user input information; and creating a risk factor identification and evaluation table based on the risk factor check list, the error log, and the discrepancy log.

The likelihood evaluation criteria scores may be category-specific likelihood evaluation criteria scores set to be within a plurality of categories classified according to likelihood evaluation criteria assessment standards, while the consequence evaluation criteria scores are category-specific consequence evaluation criteria scores set to be within a plurality categories classified according to consequence evaluation criteria assessment standards. The risk level assessment table may be created so as to be comprised of scores obtained by multiplying the category-specific likelihood evaluation criteria scores and the category-specific consequence evaluation criteria scores.

The tasks may be classified by categories, subcategories, and sub-subcategories. The step of creating the risk factor check list may include matching codes to the tasks classified by the sub-subcategories, which are lowest categories.

The step of creating the error log may include extracting information, including liable person code, declaration number, block number, correction date and time, repair category, correction category, item code, error score, error score after change, details before correction, and details after correction, from the raw data, and inputting the extracted information to the error log.

The step of creating the error log may include, when the information extracted from the raw data is input to the error log, inputting the extracted information to the error log to be arranged based on the declaration number information.

The first user input information may be information regarding reasons for liability, information regarding analysis of causes of errors, task classification information, risk factor information, and consequence evaluation criteria information. The step of creating the error log may include encoding and managing error details in the error log, based on the task classification information and the risk factor information, the error details in the error log being managed by being matched to codes used in management of the risk factor check list.

The second user input information may be task classification information, risk factor information, and consequence evaluation criteria information, according to the abnormal event information. The step of creating the discrepancy log may include encoding and managing details of abnormal events in the discrepancy log, based on the task classification information and the risk factor information, the details of abnormal events in the discrepancy log being managed by being matched to codes used in the management of the risk factor check list.

The step of creating the risk factor identification and evaluation table may include: inputting information read from the risk factor check list to the risk factor identification and evaluation table, inputting likelihood evaluation criteria scores determined by comparing numbers of code-specific errors, among errors in the error log, with law compliance standards of likelihood evaluation criteria assessment standards used for setting likelihood evaluation criteria scores, as likelihood evaluation criteria information, to the risk factor identification and evaluation table, inputting likelihood evaluation criteria scores determined by comparing numbers of code-specific abnormal events, among abnormal events in the discrepancy log, with security management standards of likelihood evaluation criteria assessment standards, as likelihood evaluation criteria information, to the risk factor identification and evaluation table, and inspecting event-specific consequence evaluation criteria information while counting the errors in the error log and the abnormal events in the discrepancy log, and inputting the event-specific consequence evaluation criteria information to the risk factor identification and evaluation table.

The step of creating the risk factor identification and evaluation table may include calculating degrees of risk based on the likelihood evaluation criteria information and the consequence evaluation criteria information, determining levels of risk by comparing the calculated degrees of risk with the risk level assessment table, and inputting the degrees of risk and the levels of risk to the risk factor identification and evaluation table.

The step of creating the risk factor identification and evaluation table may include, when a level of risk is high, creating and inputting a management number to the risk factor identification and evaluation table, and after having created the management number, creating a report of risk security measures and a report of evaluation of corrective action plan, in connection with the management number.

According to exemplary embodiments, risk factor management technology for managing risk factors to improve scores with regard to law compliance, as key references, in AEO certificate, is proposed.

The use of risk factor management technology according to exemplary embodiments makes it possible to acquire scores required for law compliance, as key references, in AEO certificate.

In addition, the use of risk factor management technology according to exemplary embodiments makes it possible to automate paperwork requiring a large amount of time, costs, and labor costs, thereby reducing costs, labor costs, and time required for preparation for certificate processes and post management.

Furthermore, the use of risk factor management technology according to exemplary embodiments makes it possible to improve the efficiency, ease, and convenience of preparation for certificate processes and post management.

### BRIEF DESCRIPTION OF THE DRAWINGS

FIG. 1 illustrates a configuration of a risk factor management system according to exemplary embodiments;

FIG. 2 illustrates a configuration of a central management server of the risk factor management system according to exemplary embodiments;

FIG. 3 illustrates an example in which likelihood evaluation criteria scores used for the creation of a risk level assessment table are set according to standards in risk factor management technology according to exemplary embodiments;

FIG. 4 illustrates an example in which consequence evaluation criteria scores used for the creation of a risk level assessment table are set according to standards in risk factor management technology according to exemplary embodiments;

FIG. 5 illustrates an example of the risk level assessment table used in risk factor management technology according to exemplary embodiments; and

FIG. 6 illustrates a method of managing risk factors in an AEO certificate process according to exemplary embodiments.

### DETAILED DESCRIPTION

Structural or functional descriptions regarding embodiments of the present disclosure are provided by way of example to explain the present disclosure. Embodiments of the present disclosure may be implemented in a variety of forms and should not be understood as being limited to those described herein.

Reference will now be made in detail to various embodiments of the present disclosure, specific examples of which are illustrated in the accompanying drawings and described hereinafter, since the embodiments of the present disclosure can be variously modified in many different forms. While the present disclosure will be described in conjunction with exemplary embodiments thereof, it is to be understood that the present description is not intended to limit the present disclosure to those exemplary embodiments. On the contrary, the present disclosure is intended to cover not only the exemplary embodiments, but also various alternatives, modifications, equivalents and other embodiments that may be included within the spirit and scope of the present disclosure as defined by the appended claims.

It will be understood that, although terms, such as “first” and “second,” may be used herein to describe various elements, these elements should not be limited by these terms. These terms are only used to distinguish one element from another element. For instance, a first element discussed below could be termed a second element without departing from the teachings of the present disclosure. Similarly, a second element could also be termed a first element.

It will be understood that when an element is referred to as being “coupled” or “connected” to other elements, it can be directly coupled or connected to the other elements or intervening elements may be present therebetween. In contrast, it should be understood that when an element is referred to as being “directly coupled” or “directly connected” to other elements, there are no intervening elements present therebetween. Other expressions that explain the relationship between elements, such as “between,” “directly between,” “adjacent to,” or “directly adjacent to,” should be construed as being used herein in the same manner.

The terminology used herein is for the purpose of describing particular embodiments only and is not intended to be limiting. As used herein, the singular forms “a,” “an,” and “the” are intended to include the plural forms as well, unless the context clearly indicates otherwise. It will be further understood that the terms “comprise”, “include”, “have”, etc., when used herein, specify the presence of stated features, integers, steps, operations, elements, components, and/or combinations thereof but do not preclude the presence or addition of one or more other features, integers, steps, operations, elements, components, and/or combinations thereof.

Unless otherwise defined, all terms including technical and scientific terms used herein have the same meaning as the meaning thereof which would be commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

When a specific embodiment can be implemented in a different manner, functions or operations defined in a specific block may be performed differently from the sequence represented in a flowchart. For example, two consecutive blocks may be performed substantially simultaneously, or may be performed in inverse sequence, depending on related functions or operations.

Hereinafter, a system and method for managing risk factors in an authorized economic operator (AEO) certificate process, according to exemplary embodiments, will be described in detail with reference to the accompanying drawings.

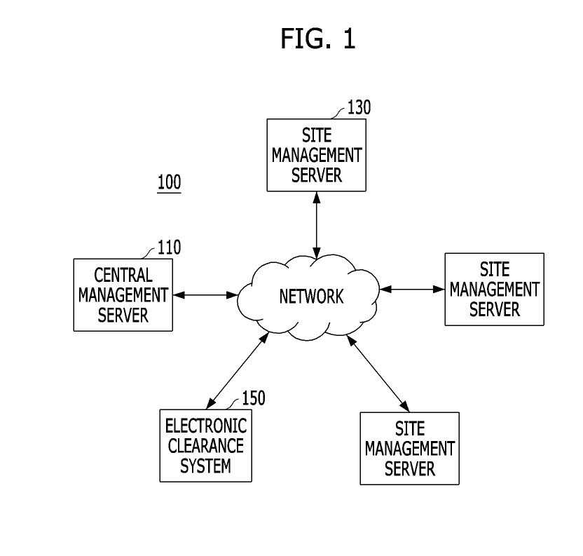

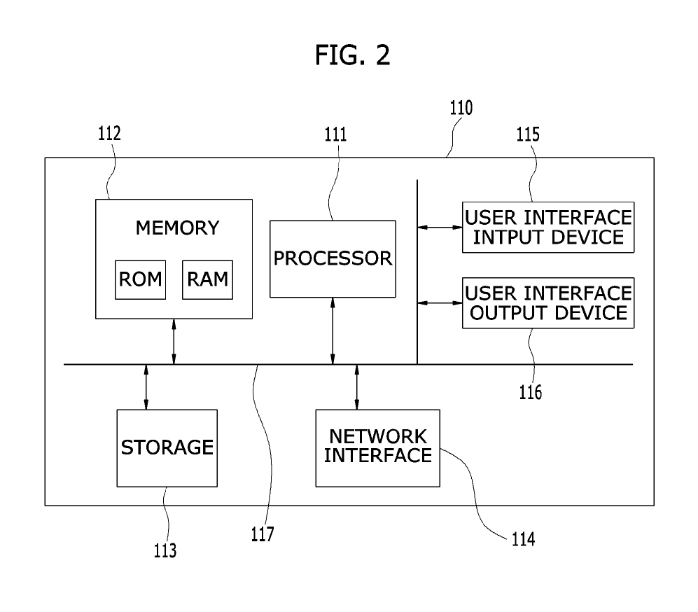

FIG. 1 illustrates a configuration of a risk factor management system according to exemplary embodiments, and FIG. 2 illustrates a configuration of a central management server of the risk factor management system according to exemplary embodiments.

Referring to FIG. 1, the risk factor management system 100 according to exemplary embodiments is configured to manage risk factors in an AEO certificate process.

Specifically, the risk factor management system 100 may include a central management server 110 and site management servers 130. A plurality of site management servers 130 may be connected to a single central management server 110 via a network.

As illustrated in FIG. 2, the central management server 110 may include at least one processor 111 executing functions, at least one memory 112 and storage 113 storing an algorithm (or a program) necessary for the execution of functions and results of the execution of functions, at least one communications module 114 for communications with an external device, a user input device 115, a user output device 116, and a communications bus 117.

The processor 611 may be a central processing unit (CPU) or a semiconductor device processing an algorithm (or a program) stored in the memory 112 and/or the storage 113.

Each of the memory 112 and the storage 113 may be one of a range of volatile or non-volatile storage mediums.

For example, the memory 112 may be one selected from among, but is not limited to, NAND flash memories, such as a compact flash (CF) card, a secure digital (SD) card, a memory stick, a solid-state drive (SSD), and a micro SD; magnetic computer storage devices, such as a hard disk drive (HDD); and optical disc drives, such as compact disc read-only memory (CD-ROM) and digital versatile disc read-only memory (DVD-ROM).

The processor 111 creates a risk level assessment table based on set likelihood evaluation criteria and consequence evaluation criteria scores.

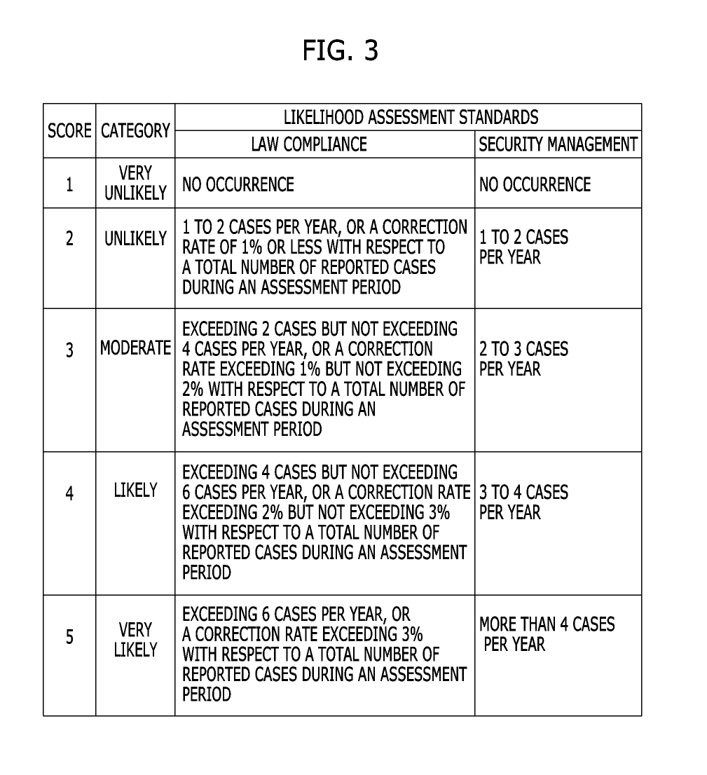

FIG. 3 illustrates an example in which likelihood evaluation criteria scores used for the creation of a risk level assessment table are set according to standards in risk factor management technology according to exemplary embodiments.

As illustrated in FIG. 3, the likelihood evaluation criteria scores are scores belonging to five categories (very unlikely, unlikely, moderate, likely, very likely), classified according to likelihood evaluation criteria assessment standards. Information recognized by the processor 111 includes likelihood evaluation criteria scores 1, 2, 3, 4, and 5.

In addition, the likelihood evaluation criteria assessment standards are categorized as a law compliance section and a security management section, with the likelihood evaluation criteria scores being applied to the law compliance section and the security management section.

That is, the likelihood evaluation criteria scores in the law compliance section are set by category, while the likelihood evaluation criteria scores in the security management section are also set by category.

Although the likelihood evaluation criteria scores are set to be within five categories (very unlikely, unlikely, moderate, likely, very likely) in FIG. 3, the categories of the likelihood evaluation criteria assessment standards may be set differently from those of the present embodiment, and the likelihood evaluation criteria scores may also be set differently from those of the present embodiment.

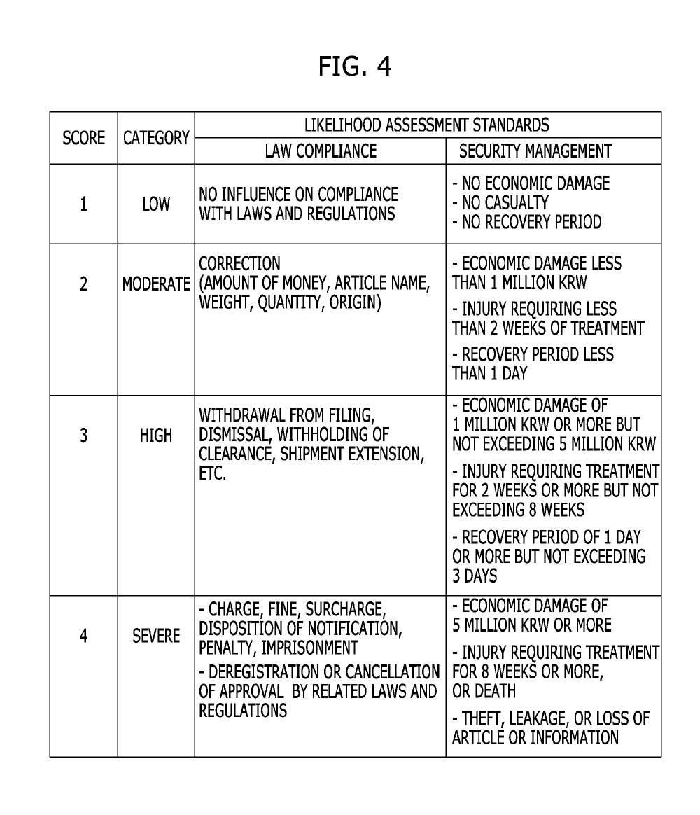

FIG. 4 illustrates an example in which consequence evaluation criteria scores used for the creation of a risk level assessment table are set according to standards in risk factor management technology according to exemplary embodiments.

As illustrated in FIG. 4, the consequence evaluation criteria scores are scores 1, 2, 3, and 4 belonging to four categories (low, moderate, high, severe). Information recognized by the processor 111 indicates the consequence evaluation criteria scores are scores 1, 2, 3, and 4.

The consequence evaluation criteria assessment standards are categorized as law compliance standards and security management standards, with consequence evaluation criteria scores being applied to the law compliance standards and the security management standards.

That is, the consequence evaluation criteria scores in the law compliance section are set by category, while the consequence evaluation criteria scores in the security management section are also set by category.

Although the consequence evaluation criteria scores are set to be within four categories (low, moderate, high, and severe) in FIG. 4, the categories of the consequence evaluation criteria scores may be set differently from the present embodiment, and consequence evaluation criteria scores may also be set differently from the present embodiment.

The likelihood evaluation criteria scores in FIG. 3 and the consequence evaluation criteria scores in FIG. 4 may be input using the user input device 115. The tables in FIGS. 3 and 4 may be output to a user by the user output device 116.

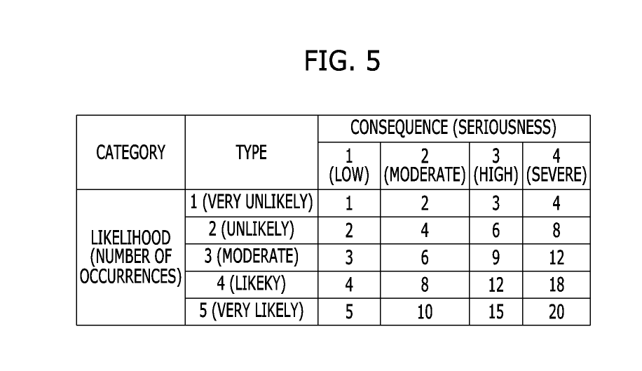

When the likelihood evaluation criteria scores are set as in FIG. 3 and the consequence evaluation criteria scores are set as in FIG. 4, the processor 111 creates a risk level assessment table, as illustrated in FIG. 5, using set likelihood evaluation criteria and consequence evaluation criteria scores.

FIG. 5 illustrates an example of the risk level assessment table used in risk factor management technology according to exemplary embodiments.

As illustrated in FIG. 5, the processor 111 creates a risk level assessment table comprised of scores obtained by multiplying category-specific likelihood evaluation criteria scores and category-specific consequence evaluation criteria scores. The risk level assessment table may be created as a matrix.

The risk level assessment table created by the processor 111, according to the present embodiment, consists of 20 scores, since there are five likelihood evaluation criteria scores and four consequence evaluation criteria scores.

The risk level assessment table illustrated in FIG. 5 may be output to a user by the user output device 116.

In addition, the processor 111 creates a risk factor check list, based on task-specific risk information and task-specific risk factor information input by the user, and codes and manages the risk factor check list in a task-specific manner. (The task-specific risk information refers to information regarding risks defined according to tasks, and the task-specific risk factor information refers to information regarding risk factors defined according to tasks.)

The risk information and the risk factor information may be defined in a task-specific manner, in which tasks may be classified by categories, subcategories, and sub-subcategories.

Accordingly, the processor 111 matches codes to the tasks classified by sub-subcategories, which are lowest categories.

Since codes are matched to the risk information and risk factor information defined according to the tasks, as described above, the processor 111 may manage the risk factor check list in connection with other information (e.g. an error log, a discrepancy log, and a risk factor identification and evaluation table).

The user may input task-specific risk information and risk factor information using the input device 115.

In addition, the processor 111 creates an error log, based on raw data provided by an external source (e.g. an electronic clearance system 150) and information input by the user (referred to as “user input information”).

The processor 111 may store the raw data provided by an external source (e.g. the electronic clearance system 150), and create an error log using the raw data, as required.

Alternatively, the processor 111 may request that an external source (e.g. the electronic clearance system 150) send the raw data, and may create an error log using the received raw data.

After having input the raw data to the error log, the processor 111 may inquire as to whether or not to proceed to the next step using a pop-up window, and when there is a request to proceed to the next step, may be converted into a state in which the processor 111 can receive information from the user.

Here, the processor 111 extracts information, including liable person code, declaration number, block number, correction date and time, repair category, correction category, item code, error score, error score after change, details before correction, and details after correction, from the raw data, and inputs the extracted information to the error log.

When pieces of information extracted from the raw data are input to the error log, the processor 111 may input the extracted pieces of information to the error log to be arranged based on the declaration number information.

In addition, the processor 111 may receive information regarding reasons for liability, information regarding analysis of causes of errors, task classification information, risk factor information, and consequence evaluation criteria information, input by the user.

The processor 111 may receive the information regarding reasons for liability and the information regarding analysis of causes of errors in text form, while receiving specific items of the task classification information, the risk factor information, and the consequence evaluation criteria information, selected by the user from an item list provided as a pop-up window.

In addition, the processor 111 codes and manages error details in the error log, based on the task classification information and the risk factor information. More particularly, the processor 111 manages the error details in the error log by matching the error details to codes used in the management of the risk factor check list.

Accordingly, in terms of the processor 111, the codes are matched to the task classification information, the risk factor information, and the consequence evaluation criteria information belonging to sub-subcategories.

When a task classification list and a risk factor list are provided as pop-up windows, the processor 111 provides a list or lists containing the task classification information and the risk factor information, defined in the risk factor check list.

Accordingly, the processor 111 may manage the risk factor check list and the error log in connection with each other, based on codes.

When a consequence evaluation criteria list is provided in a pop-up window, the processor 111 provides a list containing preset consequence evaluation criteria scores.

In addition, the processor 111 creates a discrepancy log, based on abnormal event information received from an external source (e.g. the site management servers 130).

Specifically, when an abnormal event has occurred, a site operator inputs abnormal event information, regarding the abnormal event that has occurred, to a corresponding site management server among the plurality of site management servers 130. The site management server 130 provides the abnormal event information to the central management server 110, and the processor 111 creates a discrepancy log, based on the abnormal event information received from the site management server 130.

The abnormal event information may include details of actions in a conveyance and goods controls, details of actions in a mail log, as well as subjects to be inspected and abnormalities in a facility examination and maintenance log.

In addition, the processor 111 reflects task classification information, risk factor information, and consequence evaluation criteria information, according to the abnormal event information input by the user, in the discrepancy log.

Accordingly, the abnormal event information is recorded, together with the task classification information, the risk factor information, and the consequence evaluation criteria information according to the abnormal event information, in the discrepancy log.

The processor 111 receives specific items of the task classification information, the risk factor information, and the consequence evaluation criteria information, selected by the user from an item list provided as a pop-up window.

In addition, the processor 111 codes and manages the discrepancy log, based on the task classification information and the risk factor information. More particularly, the processor 111 manages the discrepancy log by matching the details thereof to codes used in the management of the risk factor check list.

That is, when the task classification list and the risk factor list are provided in a pop-up window, the processor 111 provides a list or lists containing the task classification information and risk factor information, defined in the risk factor check list.

Accordingly, the processor 111 may manage the risk factor check list, the error log, and the discrepancy log in connection with each other, based on codes.

When the consequence evaluation criteria list is provided in a pop-up window, the processor 111 provides a list containing preset consequence evaluation criteria scores.

In addition, the processor 111 creates a risk factor identification and evaluation table, based on the risk factor check list, the error log, and the discrepancy log, having been created previously.

The processor 111 reads information in the risk factor check list and inputs the read information to the risk factor identification and evaluation table. In addition, the processor 111 determines likelihood evaluation criteria scores by comparing results, obtained by counting errors in the error log (i.e. numbers of code-specific errors) in a code-specific manner, with law compliance standards of likelihood evaluation criteria assessment standards used for setting likelihood evaluation criteria scores, and inputs the determined likelihood evaluation criteria scores as likelihood evaluation criteria information.

In addition, the processor 111 determines likelihood evaluation criteria scores by comparing results, obtained by counting abnormal events in the discrepancy log (i.e. numbers of code-specific abnormal events) in a code-specific manner, with security management standards of likelihood evaluation criteria assessment standards used for setting likelihood evaluation criteria scores, and inputs the determined likelihood evaluation criteria scores as likelihood evaluation criteria information.

When inputting the likelihood evaluation criteria information to the risk factor identification and evaluation table, the processor 111 also inputs the consequence evaluation criteria information together with the likelihood evaluation criteria information.

Since event-specific consequence evaluation criteria information is input to the error log and the discrepancy log, the processor 111 may inspect the event-specific consequence evaluation criteria information and input the inspected event-specific consequence evaluation criteria information to the risk factor identification and evaluation table.

The processor 111 may input code-specific information input by a user (e.g. department information and information regarding persons in charge) to the risk factor identification and evaluation table.

In addition, the processor 111 calculates degrees of risk based on the likelihood evaluation criteria information and the consequence evaluation criteria information, determines levels of risk by comparing the calculated degrees of risk with a risk level assessment table, and inputs the degrees of risk and the levels of risk to the risk factor identification and evaluation table.

For example, the processor 111 may divide the levels of risk into “very unlikely,” “unlikely,” “moderate,” “likely,” and “very likely.”

With reference to the risk level assessment table in FIG. 5, the processor 111 may determine the level of risk to be “very unlikely” when the likelihood evaluation criteria is 1.

In addition, when the likelihood evaluation criteria is 2 and the consequence evaluation criteria is 1 or 2, the likelihood evaluation criteria is 3 and the consequence evaluation criteria is 1, or the likelihood evaluation criteria is 4 and the consequence evaluation criteria is 1, the processor 111 may determine the level of risk to be “low.”

In addition, when the likelihood evaluation criteria is 2 and the consequence evaluation criteria is 3, the likelihood evaluation criteria is 3 and the consequence evaluation criteria is 2 or 3, or the likelihood evaluation criteria is 4 and the consequence evaluation criteria is 2, the processor 111 may determine the level of risk to be “moderate.”

Furthermore, when the likelihood evaluation criteria is 2 and the consequence evaluation criteria is 4, the likelihood evaluation criteria is 3 and the consequence evaluation criteria is 4, or the likelihood evaluation criteria is 4 and the consequence evaluation criteria is 3 or 4, or the likelihood evaluation criteria is 5 and the consequence evaluation criteria is 1 or 4, the processor 111 may determine the level of risk to be “high.”

In addition, when a level of risk is “high,” a management number is created and is input to the risk factor identification and evaluation table.

After the management number is created, the processor 111 creates a report of risk security measures and a report of evaluation of corrective action plan, in connection with the management number.

According to specific settings, the processor 111 may create and input a management number to the risk factor identification and evaluation table even in the case in which the level of risk is “low” or “moderate.”

The configurations of the risk factor management system in an AEO certificate process, as well as the functions of the configurations, according to exemplary embodiments, have been described hereinabove. Hereinafter, a method of managing risk factors in an AEO certificate process according to exemplary embodiments will be described in detail.

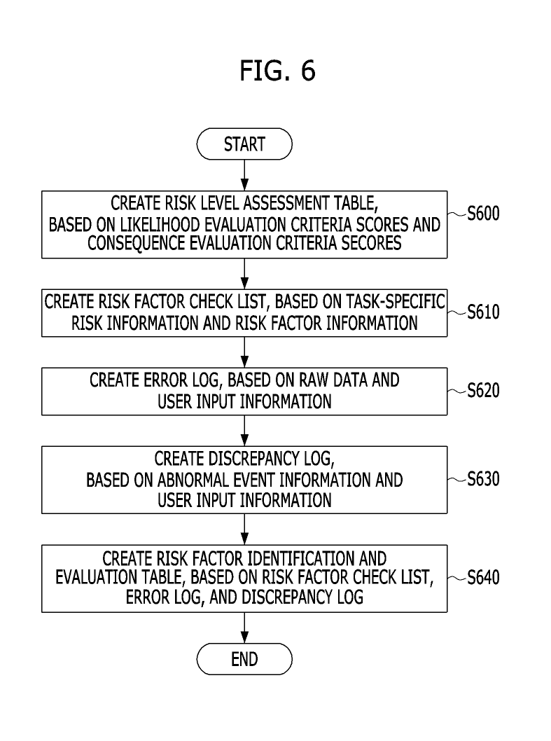

FIG. 6 illustrates a method of managing risk factors in an AEO certificate process according to exemplary embodiments.

The stepwise operations illustrated in FIG. 6 may be performed by the risk factor management system 100 described above with reference to FIGS. 1 to 5. The central management server 110 creates a risk level assessment table, based on set likelihood evaluation criteria and consequence evaluation criteria scores, in S600.

The likelihood evaluation criteria scores are set to be within a plurality of categories classified according to likelihood evaluation criteria assessment standards, while the consequence evaluation criteria scores are set to be within a plurality categories classified according to consequence evaluation criteria assessment standards.

In S600, the central management server 110 creates the risk level assessment table comprised of scores obtained by multiplying the category-specific likelihood evaluation criteria scores and the category-specific consequence evaluation criteria scores.

After S600, in S610, the central management server 110 creates a risk factor check list, based on task-specific risk information and risk factor information input by a user.

In addition, the central management server 110 codes and manages the created risk factor check list in a task-specific manner.

Here, tasks may be classified by categories, subcategories, and sub-subcategories. The central management server 110 matches codes to the tasks classified by sub-subcategories, which are lowest categories.

After S610, in S620, the central management server 110 creates an error log, based on raw data provided by an external source (e.g. the electronic clearance system 150) and information input by the user (referred to as “user input information”).

In S620, the central management server 110 may extract information, including liable person code, declaration number, block numbers, correction dates and times, repair category, correction category, item code, error score, error score after change, details before correction, and details after correction, from the raw data, and input the extracted information to the error log.

When pieces of information extracted from the raw data are input to the error log, the central management server 110 may input the extracted pieces of information to the error log by arranging the pieces of information based on the declaration number information.

In S620, the central management server 110 may receive information regarding reasons for liability, information regarding analysis of causes of errors, task classification information, risk factor information, and consequence evaluation criteria information, as user input information.

In addition, the central management server 110 codes and manages error details in the error log, based on the task classification information and the risk factor information. More particularly, the central management server 110 manages the error details in the error log by matching the error details to codes used in the management of the risk factor check list.

After S620, in S630, the central management server 110 creates a discrepancy log, based on abnormal event information received from an external source (e.g. the site management servers 130) and information input by the user (referred to as “user input information”).

In S630, the abnormal event information may include details of actions in a conveyance and goods controls, details of actions in a mail log, as well as subjects to be inspected and abnormalities in a facility inspection and repair management ledger.

In S630, the central management server 110 may receive the task classification information, the risk factor information, and the consequence evaluation criteria information according to the abnormal event information, as the user input information.

In addition, the central management server 110 codes and manages details of abnormal events in the discrepancy log, based on the task classification information and the risk factor information. More particularly, the central management server 110 manages the details of abnormal events in the discrepancy log by matching the details of abnormal events to codes used in the management of the risk factor check list.

After S630, in S640, the central management server 110 creates a risk factor identification and evaluation table, based on the risk factor check list, the error log, and the discrepancy log, having been created previously.

In S640, the central management server 110 reads information (i.e. task-specific risk information and risk factor information) in the risk factor check list and inputs the read information to the risk factor identification and evaluation table.

In addition, in S640, the central management server 110 determines likelihood evaluation criteria scores by comparing results, obtained by counting errors in the error log (i.e. numbers of code-specific errors) in a code-specific manner, with law compliance standards of likelihood evaluation criteria assessment standards used for setting likelihood evaluation criteria scores, and inputs the determined likelihood evaluation criteria scores as likelihood evaluation criteria information to the risk factor identification and evaluation table.

In addition, in S640, the central management server 110 determines likelihood evaluation criteria scores by comparing results, obtained by counting abnormal events in the discrepancy log (i.e. numbers of code-specific abnormal events) in a code-specific manner, with security management standards of likelihood evaluation criteria assessment standards used for setting likelihood evaluation criteria scores, and inputs the determined likelihood evaluation criteria scores as likelihood evaluation criteria information to the risk factor identification and evaluation table.

In addition, in S640, the central management server 110 inspects event-specific consequence evaluation criteria information while counting the errors in the error log and the abnormal events in the discrepancy log, and inputs the event-specific consequence evaluation criteria information to the risk factor identification and evaluation table.

Furthermore, in S640, the central management server 110 calculates degrees of risk based on the likelihood evaluation criteria information and the consequence evaluation criteria information, determines levels of risk by comparing the calculated degrees of risk with the risk level assessment table, and inputs the degrees of risk and the levels of risk to the risk factor identification and evaluation table.

The central management server 110 calculates the degrees of risk by multiplying the likelihood evaluation criteria information and the consequence evaluation criteria information.

In addition, in S640, when a level of risk is “high,” the central management server 110 creates and inputs a management number to the risk factor identification and evaluation table. After having created the management number, the central management server 110 creates a report of risk security measures and a report of evaluation of corrective action plan, in connection with the management number.

Although all components of the foregoing exemplary embodiments have been described as being combined together or operating together, the present disclosure is not limited thereto. Rather, one or more of all of the components may be selectively combined to operate together without departing from the scope or purpose of the present disclosure. In addition, all of the components may be implemented as an independent piece of hardware, but a portion or all of the components may be selectively combined to provide a computer program having a program module to perform a portion or all of the functions combined in one or a plurality of pieces of hardware. Furthermore, such a computer program may be stored in computer readable mediums, such as a universal serial bus (USB) memory, a compact disc read-only memory (CD-ROM), or a flash memory to be read and executed by a computer to implement the exemplary embodiments. Storage mediums for the computer program may include magnetic recording mediums, optical recording mediums, carrier waves, and so on.

Although the system and method for managing risk factors in an AEO certificate process have been described with reference to the exemplary embodiments, the scope of the present disclosure should not be construed as being limited to these specific embodiments. A person skilled in the art to which the present disclosure relates could make a variety of alternatives, modifications, and alterations without departing from the scope of the present disclosure.

Therefore, the foregoing embodiments disclosed herein and the accompanying drawings shall be interpreted as illustrative, while not being limitative, of the principle and scope of the present disclosure. It should be understood that the scope of the present disclosure shall be defined by the appended Claims and all of their equivalents fall within the scope of the present disclosure.

What is claimed is:

1. A system for managing risk factors in an authorized economic operator (AEO) certificate process,
the system comprising a central management server comprising at least one processor, wherein the processor
creates a risk level assessment table based on set likelihood evaluation criteria scores and set consequence evaluation criteria scores;
creates a risk factor check list based on information regarding risks and risk factors input by a user, the risks and the risk factors being provided according to tasks;
creates an error log based on externally-provided raw data and first user input information;
creates a discrepancy log based on externally-provided abnormal event information and second user input information; and
creates a risk factor identification and evaluation table based on the risk factor check list, the error log, and the discrepancy log.

2. The system according to claim 1, wherein the likelihood evaluation criteria scores are category-specific likelihood evaluation criteria scores set to be within a plurality of categories classified according to likelihood evaluation criteria assessment standards, while the consequence evaluation criteria scores are category-specific consequence evaluation criteria scores set to be within a plurality categories classified according to consequence evaluation criteria assessment standards, and
the processor creates the risk level assessment table comprised of scores obtained by multiplying the category-specific likelihood evaluation criteria scores and the category-specific consequence evaluation criteria scores.

3. The system according to claim 1, wherein the tasks are classified by categories, subcategories, and sub-subcategories, and
the processor matches codes to the tasks classified by the sub-subcategories, which are lowest categories.

4. The system according to claim 1, wherein the processor extracts information, including liable person code, declaration number, block number, correction date and time, repair category, correction category, item code, error score, error score after change, details before correction, and details after correction, from the raw data, and inputs the extracted information to the error log.

5. The system according to claim 4, wherein, when the information extracted from the raw data is input to the error log, the processor inputs the extracted information to the error log to be arranged based on the declaration number information.

6. The system according to claim 1, wherein the processor
receives information regarding reasons for liability, information regarding analysis of causes of errors, task classification information, risk factor information, and consequence evaluation criteria information, as the first user input information; and
codes and manages error details in the error log, based on the task classification information and the risk factor information, the error details in the error log being managed by being matched to codes used in management of the risk factor check list.

7. The system according to claim 1, wherein the processor
receives task classification information, risk factor information, and consequence evaluation criteria information, according to the abnormal event information, as the second user input information; and
codes and manages details of abnormal events in the discrepancy log, based on the task classification information and the risk factor information, the details of abnormal events in the discrepancy log being managed by being matched to codes used in the management of the risk factor check list.

8. The system according to claim 1, wherein the processor
inputs information read from the risk factor check list to the risk factor identification and evaluation table;
inputs likelihood evaluation criteria scores determined by comparing numbers of code-specific errors, among errors in the error log, with law compliance standards of likelihood evaluation criteria assessment standards used for setting likelihood evaluation criteria scores, as likelihood evaluation criteria information, to the risk factor identification and evaluation table;
inputs likelihood evaluation criteria scores determined by comparing numbers of code-specific abnormal events, among abnormal events in the discrepancy log, with security management standards of likelihood evaluation criteria assessment standards, as likelihood evaluation criteria information, to the risk factor identification and evaluation table; and
inspects event-specific consequence evaluation criteria information while counting the errors in the error log and the abnormal events in the discrepancy log, and inputs the event-specific consequence evaluation criteria information to the risk factor identification and evaluation table.

9. The system according to claim 8, wherein the processor calculates degrees of risk based on the likelihood evaluation criteria information and the consequence evaluation criteria information, determines levels of risk by comparing the calculated degrees of risk with the risk level assessment table, and inputs the degrees of risk and the levels of risk to the risk factor identification and evaluation table.

10. The system according to claim 9, wherein, when a level of risk is high, the processor creates and inputs a management number to the risk factor identification and evaluation table, and after having created the management number, creates a report of risk security measures and a report of evaluation of corrective action plan, in connection with the management number.

11. A method of managing risk factors in an authorized economic operator (AEO) certificate process, the method comprising:
creating a risk level assessment table based on set likelihood evaluation criteria scores and set consequence evaluation criteria scores;
creating a risk factor check list based on information regarding risks and risk factors input by a user, the risks and the risk factors being provided according to tasks;
creating an error log based on externally-provided raw data and first user input information;
creating a discrepancy log based on externally-provided abnormal event information and second user input information; and
creating a risk factor identification and evaluation table based on the risk factor check list, the error log, and the discrepancy log.

12. The method according to claim 11, wherein the likelihood evaluation criteria scores are category-specific likelihood evaluation criteria scores set to be within a plurality of categories classified according to likelihood evaluation criteria assessment standards, while the consequence evaluation criteria scores are category-specific consequence evaluation criteria scores set to be within a plurality categories classified according to consequence evaluation criteria assessment standards, and
the risk level assessment table is created so as to be comprised of scores obtained by multiplying the category-specific likelihood evaluation criteria scores and the category-specific consequence evaluation criteria scores.

13. The method according to claim 11, wherein the tasks are classified by categories, subcategories, and sub-subcategories, and
creating the risk factor check list comprises matching codes to the tasks classified by the sub-subcategories, which are lowest categories.

14. The method according to claim 11, wherein creating the error log comprises extracting information, including liable person code, declaration number, block number, correction date and time, repair category, correction category, item code, error score, error score after change, details before correction, and details after correction, from the raw data, and inputting the extracted information to the error log.

15. The method according to claim 14, wherein creating the error log comprises, when the information extracted from the raw data is input to the error log, inputting the extracted information to the error log to be arranged based on the declaration number information.

16. The method according to claim 11, wherein the first user input information comprises information regarding reasons for liability, information regarding analysis of causes of errors, task classification information, risk factor information, and consequence evaluation criteria information, and
creating the error log comprises encoding and managing error details in the error log, based on the task classification information and the risk factor information, the error details in the error log being managed by being matched to codes used in management of the risk factor check list.

17. The method according to claim 11, wherein the second user input information comprises task classification information, risk factor information, and consequence evaluation criteria information, according to the abnormal event information, and
creating the discrepancy log comprises encoding and managing details of abnormal events in the discrepancy log, based on the task classification information and the risk factor information, the details of abnormal events in the discrepancy log being managed by being matched to codes used in the management of the risk factor check list.

18. The method according to claim 11, wherein creating the risk factor identification and evaluation table comprises:
inputting information read from the risk factor check list to the risk factor identification and evaluation table,
inputting likelihood evaluation criteria scores determined by comparing numbers of code-specific errors, among errors in the error log, with law compliance standards of likelihood evaluation criteria assessment standards used for setting likelihood evaluation criteria scores, as likelihood evaluation criteria information, to the risk factor identification and evaluation table,
inputting likelihood evaluation criteria scores determined by comparing numbers of code-specific abnormal events, among abnormal events in the discrepancy log, with security management standards of likelihood evaluation criteria assessment standards, as likelihood evaluation criteria information, to the risk factor identification and evaluation table, and
inspecting event-specific consequence evaluation criteria information while counting the errors in the error log and the abnormal events in the discrepancy log, and inputting the event-specific consequence evaluation criteria information to the risk factor identification and evaluation table.

19. The method according to claim 18, wherein creating the risk factor identification and evaluation table comprises calculating degrees of risk based on the likelihood evaluation criteria information and the consequence evaluation criteria information, determining levels of risk by comparing the calculated degrees of risk with the risk level assessment table, and inputting the degrees of risk and the levels of risk to the risk factor identification and evaluation table.

20. The method according to claim 19, wherein creating the risk factor identification and evaluation table comprises, when a level of risk is high, creating and inputting a management number to the risk factor identification and evaluation table, and after having created the management number, creating a report of risk security measures and a report of evaluation of corrective action plan, in connection with the management number.
